(19) United States
(12) Patent Application Publication
(10) Pub. No.: US 2026/0365001 A1
(43) Pub. Date: Nov. 19, 2026

(54) METHOD FOR PRODUCING AN INTERIOR ASSEMBLY FOR A MOTOR VEHICLE, AND INTERIOR ASSEMBLY

(71) Applicant: Ford Global Technologies, LLC, Dearborn, MI (US)

(72) Inventors: Daniel Jean Bronner, Leverkusen (DE); Nazim Djoudi, Köln (DE); Waldemar Oberdoerfer, Dormagen (DE)

(73) Assignee: Ford Global Technologies, LLC, Dearborn, MI (US)

(21) Appl. No.: 19/630,549

(22) Filed: Mar. 27, 2026

(30) Foreign Application Priority Data
May 14, 2025 (DE) 102025118580.8

(51) Int. Cl. B60H 1/34; B60H 1/24

(52) U.S. Cl. CPC B60H 1/34; B60H 1/242; B60H 2001/3492

(57) ABSTRACT

A method for producing an interior assembly for a motor vehicle to create a more efficient construction of the interior for different motor vehicles based on one platform. The method having the steps of determining a type of the interior assembly selected from a plurality of types that are based on a common vehicle platform, providing a defroster module identical for all types assigned to a windshield defroster having a defroster channel that is designed to conduct a defroster air flow, and at least one type-specific additional part having a design which depends on the determined type, and combining the defroster module and the at least one additional part to assemble the interior assembly.

### CROSS-REFERENCE TO RELATED APPLICATION

This application claims foreign priority benefits under 35 U.S.C. § 119(a)-(d) to German Application No. DE 102025118580.8 filed May 14, 2025, which is hereby incorporated by reference in its entirety.

### FIELD OF THE DISCLOSURE

The present disclosure generally relates to a method for producing an interior assembly for a motor vehicle, and also relates to an interior assembly for a motor vehicle.

### BACKGROUND OF THE DISCLOSURE

Motor vehicles of different models and the variants thereof are sometimes based on a common platform. For example, the chassis and the bodywork, but also other components, are at least partially the same in all motor vehicles with a common platform. However, depending on the model and variant, other components may have different designs. This may concern not only external components such as windshields, side windows or paneling, but also interior components. The design of A surfaces, which are the surfaces that are visible to the user, may make it more difficult to use standard parts. Such surfaces are often intended to have a specific appearance which is characteristic, for example, for a model or a variant. It is also possible for different dimensions of the interior, for example a different width, or different designs of adjoining components such as windows or bodywork parts, to oppose the use of standard parts.

There is still room for enhancements in relation to an efficient construction of the interior in different motor vehicles that are based on a common platform.

### SUMMARY OF THE DISCLOSURE

According to a first aspect of the present disclosure, a method for producing an interior assembly for a motor vehicle includes the steps of determining a type of the interior assembly selected from a plurality of types that are based on a common vehicle platform, providing a defroster module identical for all of the plurality of types and assigned to a windshield defroster having a defroster channel designed to conduct a defroster air flow and at least one type-specific additional part having a design that depends on the determined type, and combining the defroster module and the at least one additional part to assemble the interior assembly.

Embodiments of the first aspect of the present disclosure can include any one or a combination of the following features:
the additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening;
each defroster covering has a covering connecting region, the shape of which is matched to a shape of a channel connecting region of the defroster channel;
the covering connecting region and the channel connecting region are connected together;
the defroster covering has a shape adapted at the front, with respect to a vehicle longitudinal axis, to a type-dependent shape of a windshield;
the at least one air outlet opening is arranged, with respect to a vehicle transverse axis, in a central region of the defroster covering and is designed to partially direct the defroster air flow laterally toward an outside with respect to the vehicle transverse axis;
the central region extends, with respect to the vehicle transverse axis, over at most 70 % of the defroster covering;
the defroster covering is combined with two lateral connection parts which have connection-part covering surfaces which, in an installed state, extend, with respect to the vehicle transverse axis, to sides of the defroster covering surface in a direction of front support pillars of the motor vehicle, and which at least partially form a covering of the front support pillars;
at least one additional channel is provided as the additional part and connected to the defroster channel;
each additional channel is intended to conduct an air flow separate from the defroster air flow;
the defroster channel is connected in a materially bonded manner to at least one of the defroster covering and to the at least one additional channel;
a dashboard is provided in addition to the defroster covering;
the interior assembly is assembled such that the dashboard is arranged to a rear of the defroster covering with respect to the vehicle longitudinal axis and is supported by a dash panel, while the defroster channel is supported independently of the dash panel on a bulkhead; and
a visual display element is mounted between the defroster covering and the dashboard such that it is supported at least partially via the defroster channel.

According to a second aspect of the present disclosure, a method for producing an interior assembly for a motor vehicle includes the steps of determining a type of the interior assembly selected from a plurality of types that are based on a common vehicle platform and providing a defroster module identical for all of the plurality of types and assigned to a windshield defroster having a defroster channel designed to conduct a defroster air flow and at least one type-specific additional part having a design that depends on the determined type. The additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening. Each defroster covering has a covering connecting region, the shape of which is matched to a shape of a channel connecting region of the defroster channel. The covering connecting region and the channel connecting region are connected together. The defroster covering has a shape adapted at the front, with respect to a vehicle longitudinal axis, to a type-dependent shape of a windshield. An additional step is included combining the defroster module and the at least one additional part to assemble the interior assembly.

Embodiments of the second aspect of the present disclosure can include any one or a combination of the following features:
the at least one air outlet opening is arranged, with respect to a vehicle transverse axis, in a central region of the defroster covering and is designed to partially direct the defroster air flow laterally toward an outside with respect to the vehicle transverse axis;
the central region extends, with respect to the vehicle transverse axis, over at most 70 % of the defroster covering;
the defroster covering is combined with two lateral connection parts which have connection-part covering surfaces which, in an installed state, extend, with respect to the vehicle transverse axis, to sides of the defroster covering surface in a direction of front support pillars of the motor vehicle, and which at least partially form a covering of the front support pillars;
at least one additional channel is provided as the additional part and connected to the defroster channel;
each additional channel is intended to conduct an air flow separate from the defroster air flow;
the defroster channel is connected in a materially bonded manner to at least one of the defroster covering and to the at least one additional channel;
a dashboard is provided in addition to the defroster covering;
the interior assembly is assembled such that the dashboard is arranged to a rear of the defroster covering with respect to the vehicle longitudinal axis and is supported by a dash panel, while the defroster channel is supported independently of the dash panel on a bulkhead; and
a visual display element is mounted between the defroster covering and the dashboard such that it is supported at least partially via the defroster channel.

According to a third aspect of the present disclosure, an interior assembly for a motor vehicle is produced using a method comprising the steps of determining a type of the interior assembly selected from a plurality of types that are based on a common vehicle platform, providing a defroster module identical for all of the plurality of types and assigned to a windshield defroster having a defroster channel designed to conduct a defroster air flow and at least one type-specific additional part having a design that depends on the determined type, and combining the defroster module and the at least one additional part to assemble the interior assembly.

Embodiments of the third aspect of the present disclosure can include any one or a combination of the following features:
the additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening;
each defroster covering has a covering connecting region, the shape of which is matched to a shape of a channel connecting region of the defroster channel; and
the covering connecting region and the channel connecting region are connected together.

These and other features, advantages, and objects of the present disclosure will be further understood and appreciated by those skilled in the art by reference to the following specification, claims, and appended drawings.

### BRIEF DESCRIPTION OF THE DRAWINGS

### In the drawings

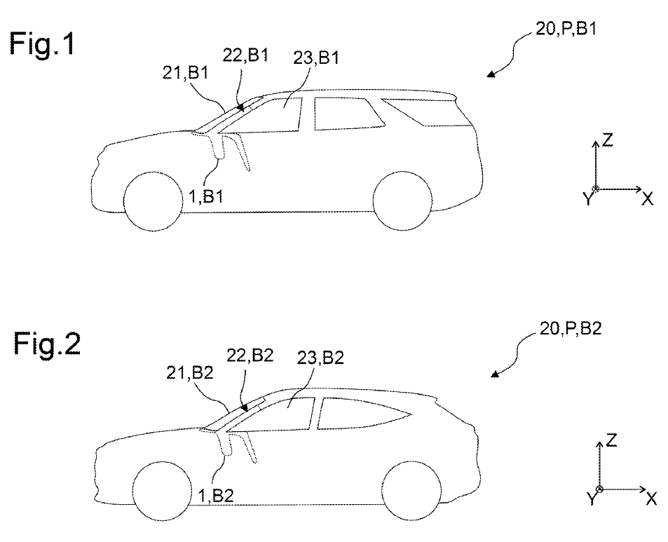

FIG. 1 is a side view of a first type of a motor vehicle having an interior assembly produced according to one example;

FIG. 2 is a side view of a second type of a motor vehicle having a second interior assembly produced according to another example;

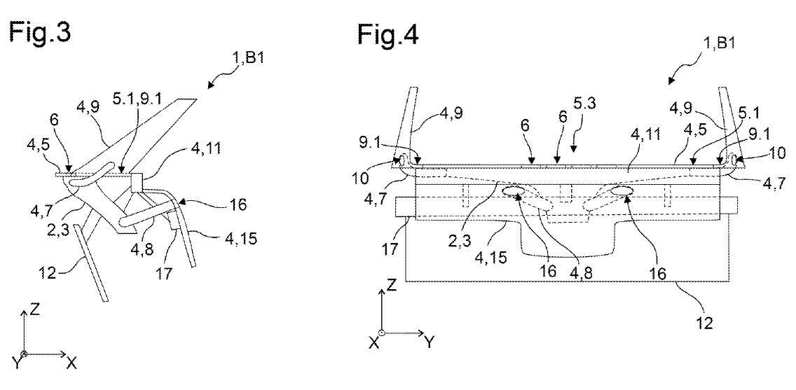

FIG. 3 is a side view of the interior assembly from FIG. 1;

FIG. 4 is a rear view of the interior assembly from FIG. 1;

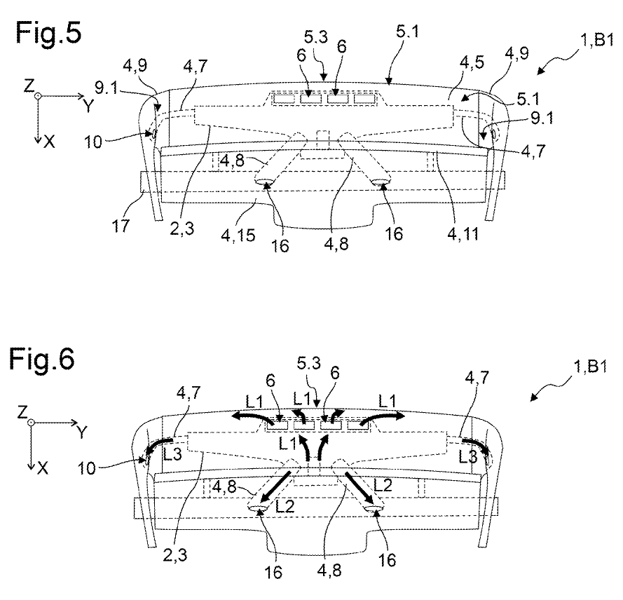

FIG. 5 is a plan view of the interior assembly from FIG. 1;

FIG. 6 is a plan view corresponding to FIG. 5, in which air flows are illustrated;

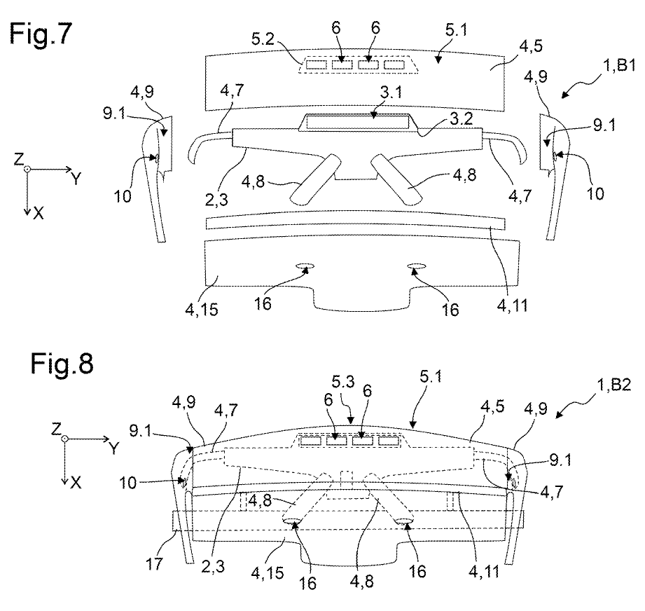

FIG. 7 is an exploded view of the interior assembly from FIG. 1; and

FIG. 8 is a plan view of the interior assembly from FIG. 2.

### DETAILED DESCRIPTION OF PREFERRED EMBODIMENTS

In the different figures, identical parts are always provided with the same reference signs, for which reason these parts are generally also described only once. The terms “first”, “second” etc. which are used in this application serve only for the purpose of differentiation. In particular, their use is not intended to imply any sequence or priority of the objects specified in conjunction with these terms.

FIG. 1 shows a first type B1 of a motor vehicle 20 having a first interior assembly 1, while FIG. 2 shows a second type B2 of a motor vehicle 20 having a second interior assembly 1, these each having been produced using a method according to the disclosure. Here and in the following figures, a vehicle longitudinal axis X, a vehicle transverse axis Y and a vehicle vertical axis Z are indicated. The two types B1, B2 are based on a common vehicle platform P and thus match to a certain extent. However, there are also differences, which relate in particular to elements of the bodywork. Specifically, in the two types B1, B2, the shape of a windshield 21 differs, as do the shape and spacing of two A-pillars 22 that separate the windshield 21 from side windows 23.

FIGS. 3-6 show the first interior assembly 1, which corresponds to the first type B1. For the production thereof, a defroster module 2 is provided, which is identical for all the types B1, B2 based on the vehicle platform P. The defroster module 2 is formed by a defroster channel 3, which, in the assembled state, is connected to a ventilation system (not illustrated here) of the motor vehicle 20. It is connected in a materially bonded manner, for example by welding, to a defroster covering 5, which has a defroster covering surface 5.1. The latter is visible and accessible from the interior of the motor vehicle 20. Arranged within the defroster covering surface 5.1 are a plurality of air outlet openings 6, which communicate with the defroster channel 3. By way of the air outlet openings 6, a defroster air flow L1 illustrated in FIG. 6 can be directed toward the inside of the windshield 21, with the result that, for example, moisture can be removed from the inside or ice on the outside can be thawed. Furthermore, two side channels 7 are arranged to the sides of the defroster channel 3 with respect to the vehicle transverse axis Y, these side channels likewise being connected in a materially bonded manner to the defroster channel 3. Two vent channels 8 are connected in a materially bonded manner to the rear of the defroster channel 3 with respect to a vehicle longitudinal axis. The four illustrated channels 7, 8 form additional channels, which are intended to conduct air flows L2, L3 that are separate from the defroster air flow L1. In alternative embodiments that are not illustrated here, the side channels 7 and/or the vent channels 8 could be connected in a non-materially bonded manner to the defroster channel 3, for example by use of a plug-in connection, a screw connection or the like. An airtight connection can be ensured by an interposed seal. As is apparent from FIG. 6, the air outlet openings 6 are arranged in a central region 5.3 of the defroster covering 5, the central region extending over less than 30 % of the defroster covering 5 with respect to the vehicle transverse axis Y. In order nevertheless to achieve effective defrosting of the windshield 21, the air outlet openings 6 are designed to direct a part of the defroster air flow L1 laterally toward the outside with respect to the vehicle transverse axis Y.

As already mentioned, the shape of the windshield 21 differs in different types B1, B2. Therefore, the defroster covering is a type-independent additional part 4 which can be selected depending on the shape of the windshield 21 and be combined with the defroster module 2. On the front side with respect to the vehicle longitudinal axis X, the defroster covering 5 has a contour which is adapted to the contour of the windshield 21. In order to take account of the fact that both the shape of the front support pillars 22 and the spacing thereof is type-dependent, lateral connection parts 9 laterally adjoin the defroster covering 5 on both sides with respect to the vehicle transverse axis Y. Each lateral connection part 9 bridges a spacing to the front support pillar 22 and it also forms a covering for the front support pillar 22. Furthermore, an air outlet opening 10 of a side channel 7 is arranged in each lateral connection part 9. Via the air outlet opening, an air flow L3 can be discharged in order to demist or de-ice the side windows 22. Arranged on the rear side of the defroster covering 5 with respect to the vehicle longitudinal axis X is a dashboard 15, which is illustrated in a highly simplified manner here. In particular, different display and operating elements have been omitted. All that is illustrated are two air outlet openings 16, into each of which one of the abovementioned vent channels 8 leads. Through the air outlet openings 16, an air flow L2 can be discharged, which flows directly to the occupants. Interposed between the defroster covering 5 and the dashboard 15 is a display element 11 (in this case an HHDD). The latter is supported partially on the defroster channel 3 and partially on a schematically illustrated dash panel 17, which is laterally attached to bodywork parts that are not illustrated. The dash panel 17 furthermore supports the dashboard 15. By contrast, the defroster module 2 is not supported by the dash panel 17 but by a bulkhead 12. The display element 11 is also only partly supported via the dash panel 17, while a substantial part of its weight force is supported via the defroster module 2 on the bulkhead. Therefore, the dash panel 17 can designed in a material-saving and lightweight manner.

As already mentioned, the design of the defroster module 2 is independent of the type B1, B2 and depends only on the vehicle platform P. The defroster covering 5, the connection parts 9, the display element 11 and the dashboard 15 form type-dependent additional parts 4, which are provided depending on the type B1, B2 and are combined with the defroster module 2. Although the interior assembly 1 is illustrated on its own in an assembled state in FIGS. 3-6, its components can be installed successively within the motor vehicle 20. FIG. 7 shows an exploded illustration of components of the interior assembly 1. It schematically indicates that the defroster channel 3 has an outlet region 3.1, to the position and extent of which the air outlet openings 6 are adapted such that the defroster air flow L1 can exit through them. The outlet region 3.1 is surrounded by a channel connecting region 3.2, which is illustrated only schematically here. A covering connecting region 5.2 that is arranged on the underside of the defroster covering 5 with respect to the vehicle vertical axis Z corresponds thereto. These connecting regions 3.2, 5.2 are matched to one another and may, for example, be shaped at least partly in a complementary manner in order to make the abovementioned materially bonded connection easier.

FIG. 8 shows a plan view of a second interior assembly 1, which is designed for the second type B2. In this type B2, the position and shape of the windshield 21 differ. Furthermore, the front support pillars 22 have a different shape and the spacing thereof with respect to the vehicle transverse axis Y is smaller. Accordingly, the interior assembly 1 according to the second type B2 differs from the one according to the first type B1 by way of different lateral connection parts 9, which have, in particular, a smaller extent along the vehicle transverse axis Y. Moreover, the defroster covering 5 has a greater extent along the vehicle longitudinal axis X and a more highly curved contour. Its covering connecting region 5.2 may be designed identically to the first type B1.

The disclosure provides a method for producing an interior assembly for a motor vehicle in a manner that creates an efficient construction of the interior for different motor vehicles based on one platform. The motor vehicle may be in particular a passenger vehicle, a truck or a bus. The interior assembly that is produced using the method according to the disclosure is assigned, in the assembled state, to the interior, more specifically the passenger compartment, of the motor vehicle. Individual components of the interior assembly may in this case directly adjoin the vehicle interior and have at least one surface that is accessible from the interior. Although other components of the interior assembly may be arranged in the vicinity of the interior, they are not directly accessible in the mounted state. The method according to the disclosure serves to produce the interior assembly, but this should not be interpreted as meaning that it has to contain all the method steps required for producing the assembly. At least in some embodiments, it is also possible to speak of a method for mounting, for assembling or for installing the interior assembly. The method has at least the following steps, wherein the order in which the steps are carried out does not absolutely have to correspond the order in which they are mentioned. Where appropriate, the order of steps can be reversed or individual steps can also be carried out simultaneously.

In one step of the method, a type is determined, which has been selected from a plurality of types that are based on a common vehicle platform. The term “vehicle platform” or “platform” for short denotes a base of technical type, which defines common technical components, for example components of the bodywork, of the chassis, of the tank, of the electronics or the like. This platform is used as the starting point for different types, this meaning different vehicle models and/or variants. Large parts of the bodywork can differ in different types. The type-specific components built on the vehicle platform are also referred to as “top hat”. Although the present text refers to “determining the type”, in practice, the corresponding type is normally implicitly defined in that the interior assembly is intended to be installed in a specific motor vehicle. In this regard, the actual determining of the type takes place typically long before the actual assembly of the interior assembly begins. In any case, in the method, one or a number of possible types can be used as a basis. Typically, not only external dimensions of the motor vehicle but also different dimensions of the vehicle interior depend on the type, although all types are based on the same vehicle platform. This in turn can require different dimensions of the interior assembly.

In a further step, a defroster module is provided which is identical for all types, is assigned to a windshield defroster and has a defroster channel that is designed to conduct a defroster air flow, and at least one type-specific additional part is provided, the design of which depends on the determined type. The windshield defroster or “defroster” for short serves to discharge an air flow toward the inside of the windshield. This may serve to supply heat to the windshield and to de-ice the windshield in the event of low temperatures. In addition, the defroster can also be used to remove condensed moisture from the inside of the windshield. In any case, the defroster is based on an air flow. The defroster module is assigned to the defroster and may form a part of the defroster. However, this does not preclude the defroster module being identical to the defroster or the defroster module having parts that functionally do not actually belong to the defroster. The defroster module may be formed in one piece, but may also have a plurality of elements that are connected together at least after the interior assembly has been completed. Such elements may be connected together detachably or non-detachably. A connection may be based on a force-fit, a form-fit and/or a material bond. The defroster module may be identical for all types that are based on the vehicle platform. Thus, it is platform-specific but not type-specific. The defroster module has a defroster channel that is designed to conduct a defroster air flow. In some embodiments, the defroster channel may also form the defroster module. In any case, it forms a type-independent, standardized element. It may serve for connection to a ventilation system of the motor vehicle. In the assembled state, it can be connected directly or indirectly to a fan. The defroster channel may have a wide variety of forms and flow guides connected therewith. In particular, it may be branched. It is also possible for a plurality of defroster channels to be provided, which are not connected directly together. These may notionally also be understood as being sub-channels of a single defroster channel. The defroster channel is concealed inside the fully assembled motor vehicle by different other components, and so it is not seen by the occupant. It is also possible, on account of the structural matches, for one and the same defroster channel to be used in different types of one and the same vehicle platform. In addition, at least one type-specific additional part is provided, the design of which depends on the selected type. In particular, the size and/or shape of the additional part can depend on the type. Other parameters, for example the material, color, surface texture, etc., could potentially also depend on the type. “Type-specific” means that the design of the additional part differs in at least two types from the plurality of types. In some embodiments, each type may be assigned an individual design of the additional part.

In a further step, the defroster module and the at least one additional part are combined in order to assemble the interior assembly. In other words, the assembly of the interior assembly involves combining the defroster module and the at least one additional part. Expressly, the assembly may include further (sub-)steps, just like the interior assembly can have further elements. The combining may involve connecting the defroster module and the at least one additional part at least indirectly together, such as either directly or by at least one interposed further element to which the two are connected. As already mentioned above, the assembly of the interior assembly may take place within the motor vehicle in some embodiments. In other embodiments, it is conceivable for the interior assembly to be assembled outside the motor vehicle and then installed in the vehicle. In any case, the finished interior assembly has a combination of the type-specific defroster module and the type-specific additional component. While, in the fully assembled motor vehicle, the defroster module may not be visible to the user, at least one additional part may have a visible surface.

As a result of the use of the unspecific, standardized defroster module, the efficiency of the production method is enhanced in a number of ways. Firstly, the assembly of the defroster module with adjacent parts can always be effected in the same way. The production of the defroster module itself is also identical for all types, such that it is not necessary to provide production tools for different types. The always identical design of the defroster module also allows better integration of individual constituents of the module, such that these can either be manufactured in one piece from the outset or be connected together, for example in a materially bonded manner, rather than being connected by connecting elements such as screws, pins or the like. In other words, the defroster module can be manufactured more efficiently under certain circumstances. Logistical advantages may also arise, since only one storage location is required for the finished defroster modules, from which they can be retrieved for the assembly of the interior assembly. The disclosure is based on the finding that it is possible to use the same defroster module for different types. This is because different types of the same vehicle platform structurally match in many ways. Furthermore, styling aspects of the defroster module can be ignored, since components thereof are generally not visible to the user in the fully assembled motor vehicle. This is the case in particular for the defroster channel. It may also be the case that, although a component of the defroster module is visible, it is arranged in a region close to the windshield that is barely perceptible to the user, in contrast, for example, to the dashboard, which is constantly in the field of view of the driver and front passenger. Visible surfaces or surfaces that are clearly perceived by the user, in particular covering surfaces, can be realized by a type-dependent additional part.

Advantageously, the additional part provided is a defroster covering intended to be connected to the defroster channel, having a defroster covering surface and at least one air outlet opening arranged thereon, the arrangement of which is matched, in all types, to an outlet region of the defroster channel in order to allow the defroster air flow to exit the outlet region through the at least one air outlet opening. In the installed state, the defroster covering forms a part of the interior paneling of the motor vehicle. It therefore has a so-called A surface. This is referred to here as defroster covering surface. The covering surface faces the vehicle interior and is directly accessible and visible therefrom. Arranged on or within the defroster covering surface is at least one air outlet opening, may be a plurality of air outlet openings. The abovementioned defroster air flow exits through each air outlet opening and is directed toward the windshield. The arrangement of the air outlet opening(s) is matched, in all types, to an outlet region of the defroster channel, with “arrangement” referring here to the position, size and shape of the air outlet opening(s). In this case, the outlet region is a region of the defroster channel through which the defroster air flow can leave the defroster channel. With regard to the defroster air flow, the outlet region thus forms a downstream terminal region of the defroster channel. This is independent of the type, as is the defroster channel as a whole. In contrast thereto, the arrangement of the at least one air outlet opening may be type-dependent. However, the arrangement thereof cannot be selected as desired, since otherwise the exit of the defroster air flow would be disrupted or prevented. In this embodiment, the match is made such that it is possible for the defroster air flow to exit the outlet region through the at least one air outlet opening. In particular, the at least one air outlet opening can be arranged in a region that corresponds to the position and extent of the outlet region in the assembled state. Thus, the arrangement of the at least one air outlet opening is subject to a certain structural restriction, since it is necessary to ensure a connection to the outlet region that is effective in terms of flow.

In principle, an indirect connection between the defroster channel and defroster covering is conceivable, but a direct connection is preferably provided. According to such a design, each defroster covering has a covering connecting region, the shape of which is matched to a shape of a channel connecting region of the defroster channel, wherein the connecting regions are connected together. The connecting regions are intended for a direct connection, for which reason their shapes are matched to one another. The shape of the covering connecting region and the shape of the channel connecting region may be at least partially complementary to one another. It would also be conceivable for the connecting regions to have corresponding connecting structures. Such connecting structures may be designed, for example, for a latching, clamping or plug-in connection, or for a screw connection by the use of screws. The covering connecting region may be designed in an identical manner in all types, but this does not have to be the case as long as the shape thereof is matched to that of the channel connecting region in such a way as to make possible and support a connection.

According to one embodiment, the defroster covering is provided in such a way that its shape is adapted at the front, with respect to a vehicle longitudinal axis, to a type-dependent shape of a windshield. The vehicle longitudinal axis (X axis) extends counter to the direction of travel from front to rear. In this regard, the windshield of the motor vehicle is arranged on the front side of the defroster covering surface, with the windshield in turn being assigned the windshield defroster. Depending on the type of the motor vehicle, the windshield may have a different position, inclination and/or curvature. In particular the latter requires an adapted contour of the adjoining component. With the type-independent defroster module, such an adaptation is not possible; in this embodiment, it is achieved by an adapted shape of the defroster covering. The latter advantageously has a front contour that is adapted to the shape of the windshield. In this case, the defroster covering does not have to directly adjoin the windshield. A further element could also be interposed, which, however, is not suitable for compensating for different shapes of the windshield that occur in different types. Under certain circumstances, a width of the defroster covering may also be adapted to a width of the windshield.

As already stated, the matching of the at least one air outlet opening at the outlet region of the defroster channel causes structural restrictions in terms of the arrangement. A further restriction may arise from the fact that different curvatures of the windshield have the result that a different amount of space is present laterally for the air outlet openings. A more highly curved windshield restricts the available installation space to the sides more than a less curved windshield. This, in the side regions, it may not be possible to find an arrangement of the air outlet openings close to the windshield that is suitable for all types. Individual adaptation of the position of the air outlet openings would in turn be contrary to the abovementioned matching to the outlet region of the defroster channel. Therefore, in one design, the at least one air outlet opening is arranged, with respect to a vehicle transverse axis, in a central region of the defroster covering and is designed to partially direct the defroster air flow laterally toward the outside with respect to the vehicle transverse axis. The central region may extend, with respect to the vehicle transverse axis, over at most 70 % of the defroster covering, more particularly over at most 50 %, and yet more particularly over at most 30 %. Advantageously, the central region may extend, with respect to the vehicle transverse axis, over at least 10 % or at least 20 % of the defroster covering. As a result of the at least one air outlet opening being restricted to the central region, structural conflicts with differently curved windshields do not occur. Since no air outlet opening is arranged to the side of the central region, particular air guidance is necessary in order to ensure effective defrosting of the windshield. This is achieved in that the at least one air outlet opening is designed to direct a part of the defroster air flow laterally toward the outside. For this purpose, the air outlet opening may have suitable guiding elements or guiding surfaces. The precise orientation of the guiding surfaces is type-dependent and may be matched optimally to the curvature and the inclination of the windshield.

The defroster module may be combined with two lateral connection parts which have connection-part covering surfaces which, in an installed state, extend, with respect to the vehicle transverse axis, to the sides of the defroster covering surface in the direction of front support pillars of the motor vehicle. The connection parts may also be referred to as front support pillar connection parts. Depending on the type, they may serve to bridge a spacing between the defroster covering and the laterally arranged front support pillar and/or the vehicle door. The width of the defroster covering with respect to the vehicle transverse axis (Y-axis) may in this case be oriented toward the type with the smallest spacing between the two front support pillars. In the installed state, the connection-part covering surface may adjoin the defroster covering surface. However, depending on the type, there may be a slight gap between the covering surfaces, which may be caused, for example, by a gap size of, for example, at most 2 mm or 1 mm. With regard to the surface design and color, the defroster covering surface and the connection-part covering surface may be formed identically, but a different design is also possible. This depends in particular on desired requirements. In some embodiments, the two covering surfaces may be formed such that the occupants perceive them as a single surface. Each front support pillar has, for its part, a covering. According to one embodiment, this may be an element separate from the lateral connection part. However, the shape of the front support pillar and thus also the shape of its covering are generally type-dependent. If the lateral connection part and the front support pillar covering are embodied as separate elements, two type-dependent elements butt against one another here. Alternatively and preferably, it is possible to combine these two elements in one component. According to such a design, the lateral connection parts at least partially form a covering of the front support pillars.

According to one embodiment, at least one additional channel is provided as the additional part and is connected to the defroster channel, wherein each additional channel is intended to conduct an air flow separate from the defroster air flow. The respective additional channel is, just like the defroster channel, part of a system for conducting air. In particular, the channels can be connected to a common (hot) air source. The air flow conducted in the additional channel is separate from the defroster air flow, this including the possibility of it being an air flow that branches off the defroster air flow and is separate from the defroster air flow after branching off. Accordingly, it is also possible to say that an additional channel branches off the defroster channel. According to one option, side channels are arranged to the sides of the defroster channel with respect to the vehicle longitudinal axis, these side channels being intended to conduct air flows for demisting and/or de-icing side windows. Each side channel may lead, in the fully assembled motor vehicle, to a lateral air outlet opening, which is in turn designed to conduct an air flow to a side window in order to demist the side window to remove condensed moisture. The air outlet opening may be integrated, for example, laterally into the abovementioned lateral connection part. It is also possible for the additional channel provided to be at least one vent channel, which is assigned to a personal vent. Such a personal vent, or air vent, is the starting point for an air flow that can flow directly to the driver or another occupant. The personal vent may be integrated, for example, in a dashboard or a center console. The vent channel is assigned to the personal vent and, in the installed state, is connected directly or indirectly thereto. It is thus designed to conduct an air flow intended to flow toward an occupant.

In principle, the defroster channel can be connected to adjoining components by form-fitting and/or force-fitting connecting devices. In order, however, to reduce the number of required connecting devices such as screws, pins or the like, the defroster channel may be connected in a materially bonded manner to the defroster covering. The materially bonded connection may be produced, for example, by adhesive bonding or welding. Likewise, the defroster channel may be connected in a materially bonded manner to the at least one additional channel. In this way, the additional channels are connected to the defroster channel to form a single, cohesive channel system.

In a known manner, the interior assembly may have a dashboard on which, in the fully assembled state, various operating elements, display elements, but also, for example, air outlet openings can be arranged. A dashboard may advantageously be provided in addition to the defroster covering, wherein the interior assembly is assembled such that the dashboard is arranged to the rear of the defroster covering with respect to the vehicle longitudinal axis and is supported by a dash panel, while the defroster channel is supported independently of the dash panel, in particular on a bulkhead. It is conceivable for the dashboard to also be formed at least partially in a type-independent manner. In other words, parts of the dashboard, similarly to the defroster module, could be standardized and be used for all vehicles of the vehicle platform. On the other hand, different vehicles of a common vehicle platform are characterized, under certain circumstances, specifically by a different design of the dashboard. Therefore, the dashboard is typically selected at least partially in a type-dependent manner. The dashboard or at least parts thereof may also be considered as being additional parts with respect to the interior assembly. In order to structurally support the dashboard, a dash panel is provided. Such a panel extends in the direction of the vehicle transverse axis and may, in this regard, also be referred to as a cross member or dash cross member. At its ends it can be connected to lateral bodywork parts. For stability reasons, the dash panel, in contrast to the dashboard, may be produced in particular from metal, for example as a shaped sheet-metal part. Its size therefore has a considerable influence on the vehicle mass. The more elements the dash panel has to directly or indirectly support, the larger and stronger it has to be designed to be, however. Therefore, the defroster channel (or the defroster module as a whole) is installed such that it is supported independently of the dash panel. In particular, the defroster channel can be supported on a bulkhead. The bulkhead is part of the bodywork and delimits the vehicle interior toward the front, beneath the windshield.

Provision may also be made for a visual display element to be mounted between the defroster covering and the dashboard such that it is supported at least partially via the defroster channel. The display element may be in the form of a screen, optionally of a touch screen. However, it could also be a simpler element with one or more indicator lights. In the installed state, the display element is arranged next to the defroster covering and thus typically at the lower edge of the field of view of the driver or directly therebelow. The driver has to turn their gaze at most slightly downward from the road ahead in order to be able to read the display element. In this case, the display element can be arranged above a steering wheel with respect to a vehicle vertical axis. Such a display element can also be referred to as a high head-down display or HHDD. Depending on the embodiment, the mass of such a display element may be considerable and amount, for example, to several kilograms. In order to reduce support via the dashboard, this embodiment provides that the display element is supported at least partially, optionally also entirely, via the defroster channel. Accordingly, the display element is connected directly or indirectly to the defroster channel such that at least a part of its weight force can be transferred via the defroster channel to the vehicle body, in particular to the bodywork. In combination with the abovementioned embodiment, the display element is therefore also not supported or at most partially supported by the dash panel, which is thus relieved of load.

Independent disclosure protection is claimed for an interior assembly for a motor vehicle, which has been produced in particular using an above-described method, having a type which has been selected from a plurality of types that are based on a common vehicle platform, wherein a defroster module is provided which is identical for all types, is assigned to a windshield defroster and has a defroster channel that is designed to conduct a defroster air flow, and wherein at least one type-specific additional part is provided, the design of which depends on the determined type, and wherein the defroster module and the at least one additional part are combined to assemble the interior assembly.

The advantages mentioned above with regard to the method are correspondingly associated with the interior assembly. In particular, the interior assembly may be embodied according to any of the abovementioned designs or using a combination of at least two of the designs with one another.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A method for producing an interior assembly for a motor vehicle, the method comprising the following steps:
determining a type of the interior assembly selected from a plurality of types that are based on a common vehicle platform;
providing a defroster module identical for all of the plurality of types and assigned to a windshield defroster having a defroster channel designed to conduct a defroster air flow and at least one type-specific additional part having a design that depends on the determined type; and
combining the defroster module and the at least one additional part to assemble the interior assembly.

2. The method according to claim 1, wherein the additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening.

3. The method according to claim 2, wherein each defroster covering has a covering connecting region, the shape of which is matched to a shape of a channel connecting region of the defroster channel, wherein the covering connecting region and the channel connecting region are connected together.

4. The method according to any claim 2, wherein the defroster covering has a shape adapted at the front, with respect to a vehicle longitudinal axis, to a type-dependent shape of a windshield.

5. The method according to claim 2, wherein the at least one air outlet opening is arranged, with respect to a vehicle transverse axis, in a central region of the defroster covering and is designed to partially direct the defroster air flow laterally toward an outside with respect to the vehicle transverse axis, wherein the central region extends, with respect to the vehicle transverse axis, over at most 70% of the defroster covering.

6. The method according to claim 2, wherein the defroster covering is combined with two lateral connection parts which have connection-part covering surfaces which, in an installed state, extend, with respect to the vehicle transverse axis, to sides of the defroster covering surface in a direction of front support pillars of the motor vehicle, and which at least partially form a covering of the front support pillars.

7. The method according to claim 2, further comprising at least one additional channel provided as the additional part and connected to the defroster channel, wherein each additional channel is intended to conduct an air flow separate from the defroster air flow.

8. The method according to claim 7, wherein the defroster channel is connected in a materially bonded manner to at least one of the defroster covering and to the at least one additional channel.

9. The method according to claim 2, further comprising a dashboard provided in addition to the defroster covering, wherein the interior assembly is assembled such that the dashboard is arranged to a rear of the defroster covering with respect to the vehicle longitudinal axis and is supported by a dash panel, while the defroster channel is supported independently of the dash panel on a bulkhead.

10. The method according to claim 2, further comprising a visual display element mounted between the defroster covering and the dashboard such that it is supported at least partially via the defroster channel.

11. A method for producing an interior assembly for a motor vehicle, the method comprising the following steps:
determining a type of the interior assembly selected from a plurality of types that are based on a common vehicle platform;
providing a defroster module identical for all of the plurality of types and assigned to a windshield defroster having a defroster channel designed to conduct a defroster air flow and at least one type-specific additional part having a design that depends on the determined type, wherein the additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening, wherein each defroster covering has a covering connecting region, the shape of which is matched to a shape of a channel connecting region of the defroster channel, wherein the covering connecting region and the channel connecting region are connected together, and wherein the defroster covering has a shape adapted at the front, with respect to a vehicle longitudinal axis, to a type-dependent shape of a windshield; and
combining the defroster module and the at least one additional part to assemble the interior assembly.

12. The method according to claim 11, wherein the at least one air outlet opening is arranged, with respect to a vehicle transverse axis, in a central region of the defroster covering and is designed to partially direct the defroster air flow laterally toward an outside with respect to the vehicle transverse axis, wherein the central region extends, with respect to the vehicle transverse axis, over at most 70% of the defroster covering.

13. The method according to claim 11, wherein the defroster covering is combined with two lateral connection parts which have connection-part covering surfaces which, in an installed state, extend, with respect to the vehicle transverse axis, to sides of the defroster covering surface in a direction of front support pillars of the motor vehicle, and which at least partially form a covering of the front support pillars.

14. The method according to claim 11, further comprising at least one additional channel provided as the additional part and connected to the defroster channel, wherein each additional channel is intended to conduct an air flow separate from the defroster air flow.

15. The method according to claim 14, wherein the defroster channel is connected in a materially bonded manner to at least one of the defroster covering and to the at least one additional channel.

16. The method according to claim 11, further comprising a dashboard provided in addition to the defroster covering, wherein the interior assembly is assembled such that the dashboard is arranged to a rear of the defroster covering with respect to the vehicle longitudinal axis and is supported by a dash panel, while the defroster channel is supported independently of the dash panel on a bulkhead.

17. The method according to claim 11, further comprising a visual display element mounted between the defroster covering and the dashboard such that it is supported at least partially via the defroster channel.

18. An interior assembly for a motor vehicle, wherein the interior assembly is produced using a method comprising the following steps:
determining a type of the interior assembly selected from a plurality of types that are based on a common vehicle platform;
providing a defroster module identical for all of the plurality of types and assigned to a windshield defroster having a defroster channel designed to conduct a defroster air flow and at least one type-specific additional part having a design that depends on the determined type; and
combining the defroster module and the at least one additional part to assemble the interior assembly.

19. The interior assembly according to claim 18, wherein the additional part provided is a defroster covering intended to be connected to the defroster channel, having a defroster covering surface and at least one air outlet opening arranged on the defroster covering surface so as to be matched, in all of the plurality of types to an outlet region of the defroster channel in order to allow the defroster air flow to exit the outlet region through the at least one air outlet opening.

20. The interior assembly according to claim 19, wherein each defroster covering has a covering connecting region, the shape of which is matched to a shape of a channel connecting region of the defroster channel, wherein the covering connecting region and the channel connecting region are connected together.
